(19) United States
(12) Patent Application Publication
(10) Pub. No.: US 2015/0167898 A1
(43) Pub. Date: Jun. 18, 2015

(54) WHEELS FOR PRESSURE VESSEL

(71) Applicant: LINDE AKTIENGESELLSCHAFT, Munich (DE)

(72) Inventor: Derrick Ernest Hilton, Cobham (GB)

(21) Appl. No.: 14/416,095

(22) PCT Filed: Jul. 17, 2013
(86) PCT No.: PCT/EP13/65068

§ 371 Date: Jan. 21, 2015

(30) Foreign Application Priority Data
Jul. 25, 2012 (GB) 1213203.1

(51) Int. Cl. F17C 13/08; F17C 1/04; B62B 5/00

(52) U.S. Cl. CPC F17C 13/085; B62B 5/0083; F17C 1/04; F17C 2205/0161; F17C 2209/22

(57) ABSTRACT

A wheel assembly for a pressure vessel of the type having an inner pressure vessel and an outer protective jacket. The apparatus includes a de-mountable wheel assembly having at least one jacket engagement feature, arranged to operatively engage with the protective jacket in use, and at least one wheel. The wheel assembly is arranged to be operatively connectable to the protective jacket when the pressure vessel is resting on its base.

The present invention relates to a method and apparatus for providing wheels on a pressure vessel. Specifically, the present invention relates to a method and apparatus for providing wheels on a pressure vessel of the type comprising a liner and outer protective jacket.

A gas cylinder typically comprises a thick-walled steel pressure vessel. Such a gas cylinder is heavy and cumbersome. Lighter weight gas cylinders have been introduced in which the pressure vessel is wound with strengthening fibres, thus enabling its walls to be much thinner. In order to protect the vessel, or ‘liner’ as it is sometimes called, and its winding from damage, the vessel is located in an external plastics protective jacket. Such a pressure vessel is described in detail in WO 2012/038688 which is incorporated herein by reference.

It is often necessary to move gas cylinders from place to place and it is known to provide gas cylinders with wheels for this purpose. WO 2012/038688 discloses a lightweight gas cylinder comprising integral wheels. The lightweight gas cylinder has a modular outer protective jacket which broadly comprises an upper lid section comprising handles, a mid-section, and a base section comprising integral wheels. In order to assemble the gas cylinder, the lid section and mid section are assembled together around the liner, and the assembly so made is lifted by the handles and placed into the base section.

The method described above is satisfactory for pressure vessels having a capacity of less than about 30 litres. However, for pressure vessels having a capacity of 30 litres or more, the weight of the pressure vessel exceeds health and safety manual lifting allowances and such assembly is therefore not possible.

The present invention provides a pressure vessel assembly comprising: a pressure vessel comprising an outer protective jacket having a base upon which the pressure vessel rests in normal use, and a de-mountable wheel assembly comprising: at least one jacket engagement feature arranged to operatively engage with the protective jacket; and at least one wheel; wherein the de-mountable wheel assembly is arranged to be operatively connectable to the protective jacket when the pressure vessel is resting on its base.

The assembly of the present invention is advantageous as the pressure vessel does not have to be lifted to allow the wheels to be attached to it. Furthermore, the present invention is advantageous as the de-mountable wheel assembly may be used for more than one pressure vessel, thus saving on storage space and cost.

Preferably the wheel assembly comprises a locking mechanism arranged to releaseably secure the wheel assembly to the protective jacket, wherein the locking mechanism is arranged to be operable when the pressure vessel is resting on its base. This allows the wheels to be securely fastened to the pressure vessel.

In a preferred embodiment, the protective jacket comprises at least one wheel assembly engagement feature to provide additional security for the fitment of the wheel assembly and to provide a visual indicator of the location in which the wheel assembly should be fitted. This helps to improve safety by reducing the risk of the wheel assembly being fitted incorrectly.

The at least one wheel assembly engagement feature preferably comprises at least one channel integrally formed in a sidewall of the protective jacket, thus helping to reduce production cost by minimising part count and complexity.

In one preferred embodiment, when the wheel assembly is connected to the pressure vessel, the at least one wheel does not contact the surface upon which the pressure vessel rests in normal use. This allows smaller wheels to be used which is advantageous for locations having less space.

In another aspect, the present invention provides a protective jacket for a pressure vessel comprising a base and a sidewall, wherein the sidewall comprises at least one wheel assembly engagement feature integrally formed therein, and wherein no part of the wheel assembly engagement feature is located on the base. Preferably the wheel assembly engagement feature comprises at least one channel.

In a further aspect, the present invention provides a de-mountable wheel assembly for a pressure vessel of the type having an outer protective jacket, wherein the protective jacket defines a base of the pressure vessel, the wheel assembly comprising: at least one jacket engagement feature arranged to operatively engage with the protective jacket in use; at least one wheel; and a locking mechanism arranged to releaseably secure the wheel assembly to the protective jacket in use, wherein the locking mechanism is arranged to be operable when the pressure vessel is resting on its base.

In a still further aspect, the present invention provides a kit of parts for a pressure vessel assembly, the kit comprising a protective jacket and a wheel assembly as described above.

In another aspect, the present invention provides a method of attaching at least one wheel to a pressure vessel of the type comprising an outer protective jacket, wherein the protective jacket defines a base of the pressure vessel, the method comprising: providing a de-mountable wheel assembly comprising: at least one jacket engagement feature arranged to operatively engage with the protective jacket; and at least one wheel; and operatively connecting a wheel assembly to the protective jacket when the pressure vessel is resting on its base.

An example of the invention will now be described with reference to the following Figures in which:

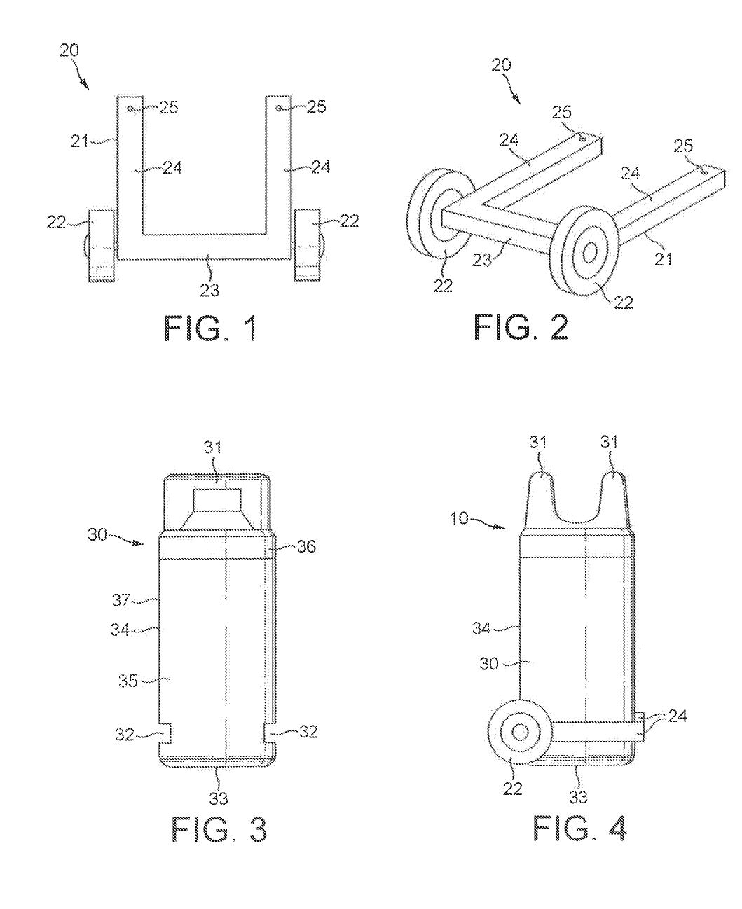

FIG. 1 is a schematic plan view of a wheel assembly;

FIG. 2 is a schematic isometric view of the wheel assembly of FIG. 1;

FIG. 3 is a schematic front view of a pressure vessel comprising an outer protective jacket; and

FIG. 4 is a schematic side view of the pressure vessel of FIG. 3 with the wheel assembly fitted.

Referring firstly to FIG. 4, a pressure vessel assembly 10 is shown comprising a pressure vessel 30 and a de-mountable wheel assembly 20. As more clearly shown in FIG. 3, the pressure vessel 30 comprises a fibre wound liner (not shown) located within a plastics outer protective jacket 34. The protective jacket 34 is made up of a lid section 36 comprising handles 31, a mid section 37 and a base 33. The mid section comprises side wall 35 in which a two channels 32 are integrally formed. In this example, the channels 32 are on opposite sides of the pressure vessel 30, in an alternative example, there may be one channel surrounding the circumference or outer periphery of the pressure vessel. In normal use, the pressure vessel rests on its base 33.

For reasons of clarity, the protective jacket 34 is shown in FIGS. 3 and 4 as a unitary object. However, although the protective jacket 34 may be a unitary object, in practice it is a modular component comprising a lid unit, a mid unit and a base unit. All of which fit together in a securely releasable manner to allow replacement of the liner.

As shown in FIGS. 1 and 2, the de-mountable wheel assembly comprises wheels 22 rotatably mounted on a frame 21 comprising an axle portion 23 and two arm portions 24. The arm portions 24 form jacket engagement features which fit into the channels 32 in use. The arm portions 24 each have a hole 25 passing through the ends of the arms 24 to allow the fitting of a securing bar (not shown). In one example the securing bar is a U-shaped steel bar which is fitted to the arms 24 by inserting the ‘legs’ of the U-shaped bar downwardly into the holes 25 and through the arms 24. Alternatively, a chain may be used, or any other suitable releasable securing mechanism. The location and size of the holes 25 may be varied from that shown to allow for the use of other types of securing mechanism. For some types of securing mechanism (for example, a tensioned strap) the holes 25 may not be necessary. If desired, the arms 24, or only the distal ends of the arms 24, may be textured or formed to assist grip between the arms 24 and the securing mechanism and/or protective jacket 34. Where texture or form are used to improve grip between the arms 24 and the protective jacket 34, these feature are considered to be jacket engagement features in the context of the invention.

The frame 21 of the wheel assembly 20 is typically made of tubular steel, and the wheels 22 are typically solid rubber. However, any other suitable materials may be used.

In use, with the pressure vessel 30 resting on its base 33, the arms 24 of the wheel assembly 20 are slotted into the channels 32. As shown in FIG. 4, when fully inserted, the arms 24 extend beyond the edge of the protective jacket 34. When fully inserted, a securing bar is inserted into the holes 25 to prevent the wheel assembly 20 disengaging from the pressure vessel 30 in use.

When fitted, the pressure vessel 30 may be moved from location to location by Upping the pressure vessel 30 back on the wheels 22 by means of the handles 31 and wheeling to the new location.

Although not shown in the Figures, the protective jacket 34 may comprise integrally formed recesses to receive the wheels 22 of the wheel assembly 20 when fitted. In an alternative embodiment (not shown) to that shown in the Figures, the wheels 22 may be sized so that they do not touch the surface upon which the pressure vessel 30 rests when the pressure vessel is in normal use. That is to say, when the pressure vessel 30 is resting on its base 33.

The embodiment described above is one example only and it will be understood that the invention may be realised in other forms, In one example (not shown) the protective jacket has no channels 32 and the frame 21 of the wheel assembly is secured to the protective jacket by means of a clamping arrangement in which the arms 24 are strapped together and tensioned. In an alternative example, the frame may have a shape which conforms to the outer surface of the protective jacket. In this example the frame 21 may be hinged so that the frame may be placed around the protective jacket and bolted together to secure the wheel assembly in place. This arrangement is suited to a protective jacket having no channels, channels 32 as shown in FIG. 3, or a continuous peripheral channel. Alternatively, the protective jacket may comprise pairs of continuous or discrete raised lug type features which define a channel or channels between them. In the case where no channel or other wheel assembly engagement feature is provided on the outer surface of the protective jacket, a high friction material may be placed between the frame of the wheel assembly and the protective jacket to improve grip. If desired, the inner surfaces of the frame members may be provided with a serrated or other textured finish to improve grip or bite between the frame members and the protective jacket. In a further alternative example, the inner surface of the frame members may comprise raised lugs which fit into complementary ‘key’ holes (or depressions) which are integrally formed in the outer surface of the protective jacket.

It will be understood that any combination as desired of the above options may be used. If desired, the frame may comprise a ‘stack’ of frame members which engage the protective jacket at a number of positions on the sidewall. Such positions may or may not be provided with complementary wheel assembly engagement features.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A pressure vessel assembly comprising:
a pressure vessel having an outer protective jacket including a base upon which the pressure vessel rests in normal use, and
a de-mountable wheel assembly having:
at least one jacket engagement feature arranged to operatively engage with the protective jacket; and
at least one wheel;
wherein the de-mountable wheel assembly is arranged to be operatively connectable to the protective jacket when the pressure vessel is resting on its base.

14. The pressure vessel assembly of claim 13, wherein the wheel assembly includes a locking mechanism to releaseably secure the wheel assembly to the protective jacket, wherein the locking mechanism is operable when the pressure vessel is resting on its base.

15. The pressure vessel assembly of claim 13, wherein the protective jacket includes at least one wheel assembly engagement feature.

16. The pressure vessel assembly of claim 15, wherein the wheel assembly engagement feature is at least one channel integrally formed in a sidewall of the protective jacket.

17. The pressure vessel assembly of claim 13, wherein the wheel of the wheel assembly does not contact the surface upon which the pressure vessel rests in normal use, when wheel assembly is connected to the pressure vessel.

18. A protective jacket for a pressure vessel having a base and a sidewalk wherein the sidewall includes at least one wheel assembly engagement feature integrally funned therein, and wherein the wheel assembly engagement feature is not associated with the base.

19. The protective jacket of claim 6, wherein the wheel assembly engagement feature is at least one channel.

20. A de-mountable wheel assembly for a pressure vessel having an outer protective jacket that includes a base for the pressure vessel, the wheel assembly comprising:
at least one jacket engagement feature arranged to engage the protective jacket;
at least one wheel; and
a locking mechanism arranged to releaseably secure the wheel assembly to the protective jacket when the pressure vessel is resting on the base.

21. A kit of parts for a pressure vessel assembly, the kit comprising:
a protective jacket having a base and a sidewalk Wherein the sidewall includes at least one wheel assembly engagement feature integrally formed therein, and wherein the wheel assembly engagement feature is not associated with the base; and
a de-mountable wheel assembly having at least one jacket engagement feature arranged to engage the wheel assembly engagement feature of the protective jacket, at least one wheel, and a locking mechanism to releaseably secure the wheel assembly to the protective jacket when the pressure vessel is resting on the base.

22. A method of attaching at least one wheel to a pressure vessel having an outer protective jacket that includes a base for the pressure vessel, the method comprising:
providing a de-mountable wheel assembly that includes at least one jacket engagement feature arranged to operatively engage with the protective jacket and at least one wheel; and
connecting the wheel assembly to the protective jacket when the pressure vessel is resting on the base.
